(19) United States
(12) Patent Application Publication
(10) Pub. No.: US 2008/0202139 A1
(43) Pub. Date: Aug. 28, 2008

(54) Vehicle Environmental Conditioning System and Method

(75) Inventors: Yann Darroman, Villabella (ES); Alberto Garcia Briz, Valls (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/678,289

(22) Filed: Feb. 23, 2007

(51) Int. Cl. B60H 1/32

(52) U.S. Cl. 62/244

(57) ABSTRACT

An air conditioning system for a vehicle includes a climate control system for selectively heating and cooling ambient air in a passenger compartment of the vehicle. One or more fans cooperate with the climate control system and are configured to draw air from the passenger compartment to expel air to the exterior of the vehicle. One or more devices are provided in proximity to the passenger compartment to detect a variety of conditions of the air in the passenger compartment. The one or more devices selectively signal a controller to activate and deactivate the one or more fans prior to an occupant entering the vehicle. The controller may activate the one or more fans to draw air from the passenger compartment based on detection of predetermined conditions in response to input from the one or more devices.

### BACKGROUND OF THE INVENTION

1. Field of the Invention

The present invention relates to an environmental conditioning system and method of conditioning the air in a passenger compartment of a vehicle.

2. Background Art

Maintaining a consistent environment in a passenger compartment of a vehicle is frequently subject to the environmental conditions outside the vehicle. For example, in the normal use of the vehicle, the vehicle is frequently parked in and exposed to the sun. When exposed to the radiant heat, the temperature of the interior or passenger compartment may become unacceptably high for occupancy, making access to the vehicle difficult until the temperature can be moderated.

Frequently, the vehicle must be cooled using the heating, ventilating and air conditioning (HVAC) system in connection with the opening of one or more doors and/or windows to allow heat to escape from the passenger compartment. This process can become time consuming and may not address the temperature of the seats and the steering wheel. Alternatively, vehicles may be equipped with systems for automatically opening windows or sun roofs or activating a seat ventilation component to evacuate heat to the exterior of the vehicle. It would be advantageous to provide a HVAC system for a vehicle incorporating one or more blowers for drawing air from a passenger compartment of a vehicle.

### SUMMARY OF THE INVENTION

An environmental conditioning system for a vehicle includes a climate control system for selectively heating and cooling ambient air in a passenger compartment of the vehicle through one or more vents in the passenger compartment. One or more fans cooperate with the climate control system and are configured to draw air from the passenger compartment to expel air to the exterior of the vehicle.

A controller is operatively connected to and in communication with the climate control system and the one or more fans. One or more devices are provided in proximity to the passenger compartment to detect a variety of conditions of the air in the passenger compartment. The one or more devices selectively signal the controller to activate and deactivate the one or more fans prior to an occupant entering the vehicle. The controller may activate the one or more fans to draw air from the passenger compartment based on detection of predetermined conditions in response to input from the one or more devices.

### BRIEF DESCRIPTION OF THE DRAWINGS

FIG. 1 is a diagram illustrating an environmental conditioning system for use with a passenger compartment in a vehicle;

FIG. 2 is a diagram illustrating the one or more fans of the environmental conditioning system provided in the vehicle;

FIG. 3 is a schematic diagram illustrating the interconnectivity of the one or more devices communicating with the controller of the environmental conditioning system; and

FIG. 4 is a block diagram illustrating the method of conditioning the environment in a passenger compartment of a vehicle.

### DETAILED DESCRIPTION

In the following figures the same reference numerals will be used to refer to the same components. While the present invention is described primarily with respect to an heating, ventilating and air conditioning (HVAC) or climate control system for a vehicle, the system may be adapted and applied in various locations within a vehicle or may be applied in other non-vehicle applications. The system may be applied in various locations within a vehicle, such as in a dashboard, in an overhead console, in a center console, in a pillar, in a door panel, or in other console or module locations where air vents or outlets may be utilized.

In the following description, various operating parameters and components are described for one constructed embodiment. These specific parameters and components are included as examples and are not meant to be limiting.

Referring now to the Figures, an environmental or air conditioning system for a vehicle and method for conditioning the environment of a passenger compartment of a vehicle is disclosed and illustrated. The system and method are capable of a quick cooling or heating of the interior, and in particular of the area corresponding to the driver. The conditioning system, uses forced air circulation to adjust the temperature of the passenger compartment, particularly when an occupant enters the car after a period in which the car was stationary and exposed to the sun, with a very high temperature inside it. The system and method additionally allow the extraction of smoke from a consumable item or unpleasant smells that can be present in the interior of the vehicle when the vehicle is in use.

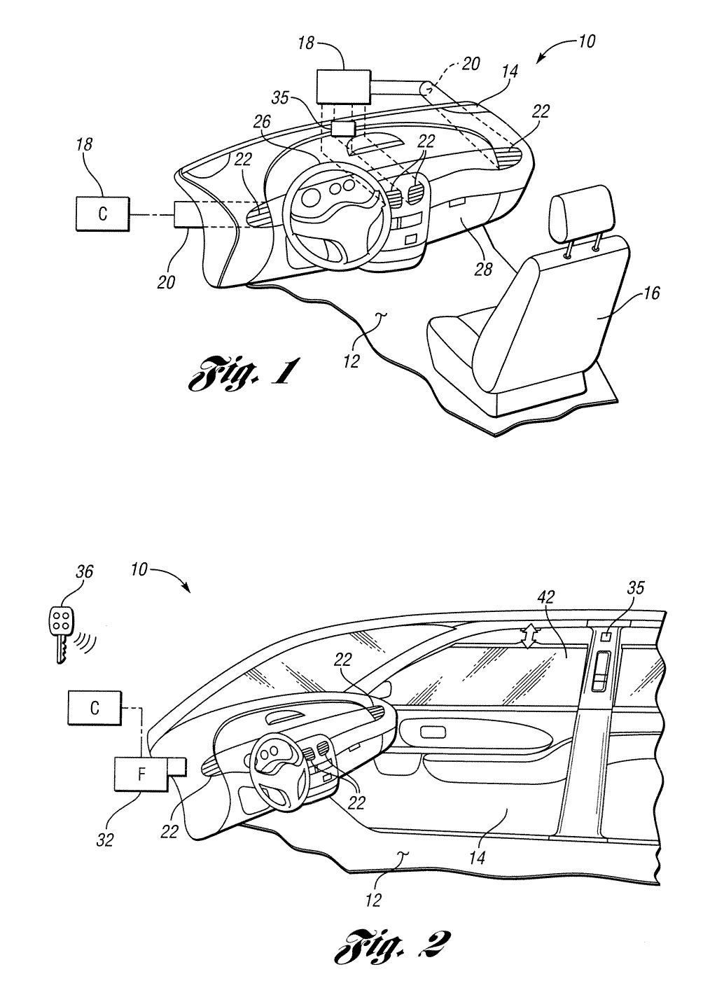

FIG. 1 illustrates the air conditioning or HVAC system 10 disposed in a passenger compartment 12 of a vehicle. Passenger compartment 12 includes a dashboard or instrument panel 14 disposed adjacent a pair of passenger seats 16. It is understood that the system disclosed herein can be provided in any portion of the passenger compartment, such as the instrument panel, the headliner, door panels, and/or other interior panels. The exact number and location of HVAC systems can be varied, depending on a number of factors. For example, differently sized vehicles may have different heating and cooling requirements, as well as more or less space available in which to locate an HVAC system.

In a typical air conditioning system illustrated in FIG. 1, air is drawn from outside the vehicle and is circulated through a climate control system, generally referenced by block 18. The climate control system may including a heater core and/or an air-conditioning evaporator that treat the air prior to delivery to the passenger compartment 12 via the air delivery ducts 20 through a vent 22 in the dashboard 14 into the passenger compartment 12. Although the system 10 is described primarily with respect to a dashboard application, air conditioning system 10 may be applied to other vehicle interior assembly applications, some of which are mentioned above.

For example, vents 22 are disposed in various locations of the passenger compartment of the vehicle, including around the steering wheel 24 which are directed at the driver's seating area, and vents disposed adjacent the glove compartment 26 aimed at the passenger's seating area. The output of these vents may reach the seating area corresponding to the rear seat of the vehicle. Alternatively, secondary vents (not shown) may be disposed adjacent the rear passenger seating area in surface materials covering support pillars or floor consoles to provide treated air to these portions of the passenger compartment of the vehicle.

A controller 30 is connected to, or otherwise in communication with, various components of the air conditioning system 10 to monitor and control the operation of the one or more components. The controller 30 may also be connected to, and can be used to control, secondary heating and cooling mechanisms, such as thermocouple elements incorporated into the vehicle seats. Alternatively, the controller may include multiple electronic control units, with each one configured to control one or more of the elements of the thermal control system. Furthermore, such multiple electronic control units may be configured to communicate with each other and/or with a primary controller.

Referring additionally now to FIG. 2, air conditioning system 10 includes one or more fans 32 disposed adjacent vents 22. Fans 32 may be used to move air into, or out of, the passenger compartment 12 of the vehicle. It is understood that the fans may be standalone devices, separate from any HVAC or climate control system. Air conditioning system 10 may have a single fan or may have more than one fan for use in the vehicle. The one or more fans 32 are provided to complement the traditional climate control system that introduces air from the exterior to the interior, with other fans functioning in the opposite direction, that is, they extract the air from the interior of the passenger compartment and send it to the exterior, generating a much quicker and more effective renewal of the air.

For example, when a single fan is employed, it may be convenient to use a bidirectional or reversible fan that is capable of exhausting air from the passenger compartment to the vehicle exterior, and blow heated or cooled air from the climate control system into the passenger compartment. When the air conditioning system is configured with more than one fan, the different fans could be oriented in different direction, the one or more fans could exhaust air, while one or more fans could blow air into the passenger compartment. It is contemplated that the one or more fans may be located adjacent the driver's seating area of the passenger compartment to concentrate the thermal conditioning effect on this area and secondarily condition the adjacent seating areas of the rest of the passengers. The unidirectional fans can be complemented or replaced by reversing the rotational direction of the main fan of the vehicle such that it extracts the air from the interior of the vehicle rather than introducing it to the passenger compartment.

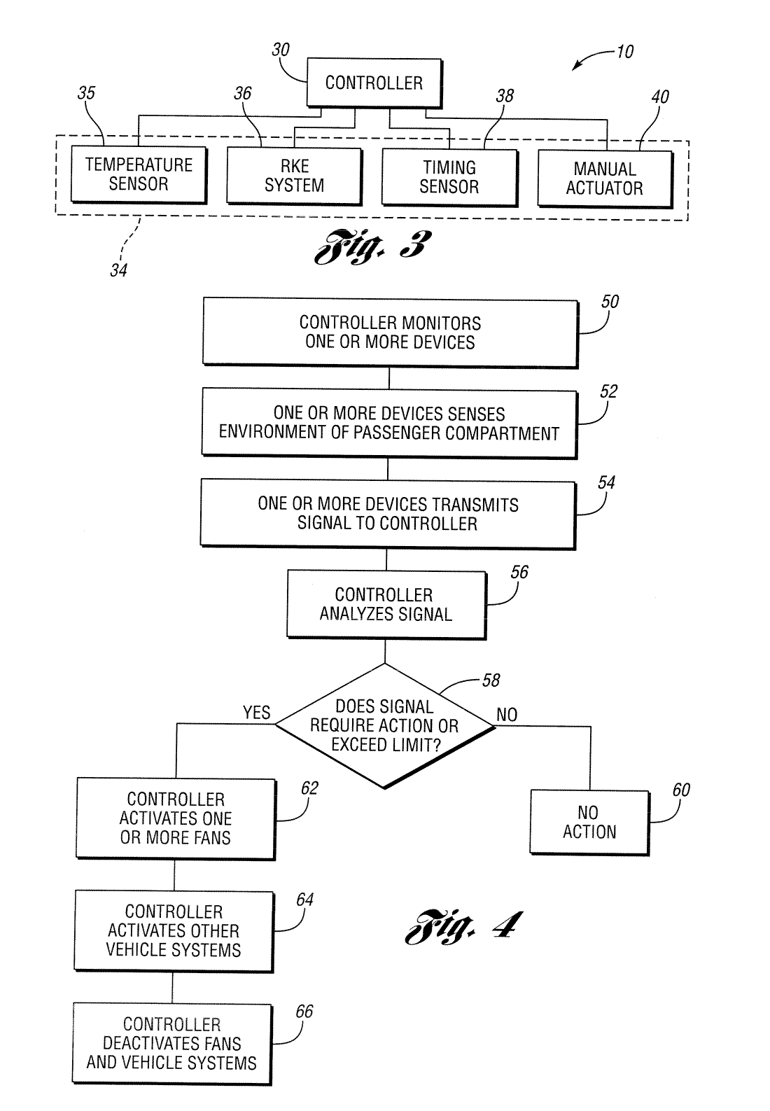

As illustrated in FIGS. 2 and 3, controller 30 is in communication with and controls the one or more fans 32. Controller 30 of air conditioning system 10 may be configured to receive a signal from one or more devices, such as an environmental sensor 35, or a remote source 36, such as a remote keyless entry system.

The controller 30 may be configured to operate the one or more fans 32 to ventilate the passenger compartment of the vehicle even when the engine is not running, and in particular, prior to the driver and/or passengers entering. The controller 30 monitors and processes input signals, such as a signal from the one or more sensors or remote source to determine whether any of the climate control devices need to be activated. As explained more fully below, the controller 30 may activate the one or more fans 32 when the temperature sensed by the one or more sensors exceeds a predetermined value. The one or more fans may also be operated when the vehicle engine is not running. In such situations, be powered by the vehicle battery, or the vehicle may be equipped with a solar panel to provide electricity without draining the battery.

One or more devices 34 may be configured to sense a variety of conditions in the passenger compartment of the vehicle, including the temperature of the ambient air in the passenger compartment of the vehicle. For example, a single temperature sensor may be used or multiple sensors may provide input to the controller. For example, the system may automatically activate the one or more fans if the temperature in the passenger compartment exceeds beyond 28° C. for the comfort of the passenger. Alternatively, the one or more fans 32 of system 10 may be actuated if the one or more sensors detect a temperature below 3° C. to pull cold air from the passenger compartment of the vehicle.

In another aspect of the invention, the one or more fans 32 may be actuated to condition the air in the passenger compartment of the vehicle based on input from one or more sensors transmitted to the controller. For example, system 10 may be actuated automatically if somebody smokes a consumable item in the passenger compartment of the vehicle. The system 10 may switch on and cause the one or more fans to extract some air from the passenger compartment if a smoke sensor, as commonly used in a house, detects smoke.

It is also feasible that such a sensor may also be used to detect a foul odor or other condition in the passenger compartment of the vehicle, such that an occupant may either manually activate the system or have the system automatically activate to extract some air. It is also contemplated that the system may include an air purifier 37, such as an air purifier incorporating ultraviolet light emitting diodes (LEDs) that break down the big molecules in the air to eliminate hazardous gases.

In addition to the inputs received from one or more devices such as the one or more sensors 35 and/or the remote source 36, the controller may also be configured to receive inputs from other sensors or devices. For example, the controller may receive a signal sent from timing sensor 38 and use this input to selectively operate the one or more fans. The sensors may continue to operate after the vehicle engine has been started, and they can continue to send signals to the controller related to the temperature of the ambient air within the passenger compartment of the vehicle. Thus the controller may operate the air conditioning system based on the processing of signals from a number of input devices.

Referring back to FIG. 3, the air conditioning system 10 may be activated by one or mor manual actuators 40 provided in the passenger compartment of the vehicle. An occupant may switch on actuator 40 to transmit a signal to the controller 30 to activate the one or more fans 32 cause air accumulated in the passenger compartment exits to the exterior extremely quickly to be renewed by exterior air. It is also contemplated that controller 30 of system 10 may control other systems of the vehicle to condition the air in the passenger compartment. For example, controller 30 may selectively operate the windows 42 or doors 44 as shown in FIG. 2 of the vehicle to open the passenger compartment 12 to the exterior environment surrounding the vehicle 10 to condition the air in the passenger compartment. The devices can be actuated either manually from inside the interior of the vehicle, automatically by means of sensors, or by means of the remote control built into the key of the vehicle.

The operation of the one or more fans 32 may be based on the inputs from the one or more devices 34 or may be based on inputs from other devices. For example, as described above, remote source 36 may include a portion of the vehicle's remote keyless entry (RKE) system. When the driver is at a distance of a few yards from the vehicle, the driver may activate the passive key entry which allows the driver to unlock the vehicle without the use of the key. When receiving the RKE signal, if the controller 30 detects one of the conditions with the one or more devices 34, the controller activates the one or more fans to condition the environment in the passenger compartment of the vehicle. For instance, if the maximum temperature is reached and if the RKE allows the unlocking of the car, therefore the fan switches on in order to extract as heat as possible from the compartment for the comfort of the occupant.

Alternatively, the driver of the vehicle may use the RKE system to send a signal from the RKE fob to the controller to activate the one or more fans. Just prior to entering the vehicle, the driver sends a signal to the vehicle's remote entry system, a signal which may cause the doors to unlock, an alarm system to disarm, and may even start the vehicle engine. In addition, the signal can be configured to provide the controller with an input that activates the one or more fans to ventilate the passenger compartment of the vehicle. Thus, there are any number of signaling devices that can be used to signal the controller to activate the one or more fans prior to the driver and/or passengers entering the vehicle.

Referring now to FIG. 4, a method of conditioning the environment of a passenger compartment of a vehicle using the system is illustrated and disclosed. As shown in step 50, controller monitors the condition of the passenger compartment in a vehicle by communicating with one or more devices. In step 52, the one or more devices monitors and senses conditions in the passenger compartment. In step, 54, the one or more devices transmit a signal to the controller for analysis. It is understood that a variety of conditions may be detected by one or more devices, including time, input of a signal from the remote keyless entry system and environmental conditions such as the temperature of the ambient air in the passenger compartment.

In step 56, the controller processes and analyzes the signal input from the one or more devices. In step 58, the controller determines whether the condition of the passenger compartment exceeds a predetermined limit or threshold or if action is required based on user input. In step 60, no action is taken if the controller determines the input from the one or more devices does not exceed set limits or user input is not generated. In step 62, the controller activates the one or more fans to remove air from the passenger compartment of the vehicle to condition the environment.

In step 64, the controller selectively operates one or more vehicle systems to assist the one or more fans to condition the passenger compartment environment. These systems may include the vehicle engine or alternative power source to power the one or more fans, opening one or more windows and/or doors, activation of an air purifier or activation of the climate control system. In step 66, the controller deactivates the one or more fans and alternative vehicle systems once the passenger compartment environment reaches an acceptable tolerance level based on input from the one or more devices and/or user input.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An environmental conditioning system for a vehicle comprising:
a climate control system for selectively heating and cooling ambient air in a passenger compartment of the vehicle;
one or more fans cooperating with the climate control system configured to draw air from the passenger compartment to expel air to the exterior of the vehicle;
a controller operatively connected to and communication with the climate control system and the one or more fans; and
one or more devices provided in proximity to the passenger compartment for detecting the condition of the air and selectively signaling the controller to activate and deactivate the one or more fans prior to an occupant entering the vehicle,
wherein the controller activates the one or more fans to draw air from the passenger compartment based on detection of predetermined conditions in response to input from the one or more devices.

2. The system of claim 1 wherein the one or more fans include a single bidirectional fan cooperating with the climate control system to provide air to and draw air from the passenger compartment.

3. The system of claim 1 wherein the one or more fans include multiple unidirectional fans disposed adjacent vents in the passenger compartment to draw air from the passenger compartment.

4. The system of claim 1 wherein the one or more devices comprise one or more temperature sensors configured to sense the temperature of ambient air in the passenger compartment and transmit a signal to the controller.

5. The system of claim 1 wherein the one or more devices comprise a timer configured to transmit a signal to the controller to activate the one or more fans at a predetermined time.

6. The system of claim 1 wherein the one or more devices comprise a manual actuator configured to transmit a signal to the controller to activate the one or more fans.

7. The system of claim 1 wherein the one or more devices include a remote keyless entry system configured to transmit a signal to the controller to activate the one or more fans.

8. The system of claim 1 wherein the controller automatically activates the one or more fans when the one or more devices provide input to the controller indicative of a condition exceeding a predetermined level.

9. The system of claim 1 wherein the one or more fans are components of the climate control system.

10. The system of claim 1 wherein the one or more fans are independent of the climate control system.

11. The system of claim 1 wherein the controller selectively operates a retractable window cover in response to input from the one or more devices.

12. An environmental conditioning system incorporating a climate control system for selectively heating and cooling ambient air in a passenger compartment of a vehicle, the system comprising:
one or more fans cooperating with the climate control system configured to draw air from the passenger compartment to expel air to the exterior of the vehicle;
a controller operatively connected to and communication with the one or more fans and a remote keyless entry system of the vehicle; and
one or more devices provided in proximity to the passenger compartment for detecting the condition of the air and selectively signaling the controller to activate and deactivate the one or more fans prior to an occupant entering the vehicle,
wherein the controller activates the one or more fans to draw air from the passenger compartment based on detection of predetermined conditions in response to input from the one or more devices and an activation signal from the remote keyless entry system.

13. The system of claim 12 wherein the one or more fans include a single bidirectional fan cooperating with the climate control system to provide air to and draw air from the passenger compartment.

14. The system of claim 12 wherein the one or more fans include multiple unidirectional fans disposed adjacent vents in the passenger compartment to draw air from the passenger compartment.

15. The system of claim 1 wherein the one or more devices comprise one or more temperature sensors configured to sense the temperature of ambient air in the passenger compartment and transmit a signal to the controller.

16. The system of claim 1 wherein the one or more devices comprise a timer configured to transmit a signal to the controller to activate the one or more fans at a predetermined time.

17. The system of claim 1 wherein the one or more devices comprise a manual actuator configured to transmit a signal to the controller to activate the one or more fans.

18. A method of conditioning the environment in the passenger compartment of a vehicle, the method comprising:
providing a controller for monitoring the environmental conditions of the passenger compartment;
sending a signal to the controller from the one or more devices;
analyzing the signal input from the one or more devices; and
selectively operating one or more fans with the controller based on the analysis of input from the one or more devices to remove air from the passenger compartment.

19. The method of claim 18 further comprising the step of sensing the environmental conditions of the passenger compartment with one or more devices and transmitting signals to the controller for analysis.

20. The method of claim 18 further comprising the step of selectively operating at least one of the vehicle engine, climate control system, windows, doors and air purifier based on the analysis of input from the one or more devices to remove air from the passenger compartment.
